(19) United States
(12) Patent Application Publication
(10) Pub. No.: US 2014/0304189 A1
(43) Pub. Date: Oct. 9, 2014

(54) Software and Method for Rating a Business

(71) Applicant: G2Link LLC, Drexel Hill, PA (US)

(72) Inventors: Edward J. Sullivan, IV, Drexel Hill, PA (US); Edward J. Sullivan, V, Sea Isle City, NJ (US)

(21) Appl. No.: 14/357,624

(22) PCT Filed: Nov. 16, 2012
(86) PCT No.: PCT/US12/65678

§ 371 Date: May 12, 2014

Related U.S. Application Data
(60) Provisional application No. 61/560,775, filed on Nov. 16, 2011.

(51) Int. Cl. G06Q 30/02

(52) U.S. Cl. CPC G06Q 30/0282
USPC 705/347

(57) ABSTRACT

The present invention provides a method for determining the business rating of a business. The method includes the steps of electronically receiving rating information about the business from a plurality of reviewers; electronically weighting the rating information based on the source of the rating information; and electronically developing a rating score based on the weighted rating information. A non-transitory machine-readable storage medium for determining the business rating of the business is also provided.

### CROSS-REFERENCE TO RELATED APPLICATION

This application claims priority from U.S. Provisional Patent Application Ser. No. 61/560,775, filed on Nov. 16, 2011, which is incorporated herein by reference in its entirety.

### FIELD OF THE INVENTION

The present invention relates to a method for rating a business based on input from others who interact with the business, as well as software to perform the method.

### BACKGROUND OF THE INVENTION

Today there are many tools available that provide business insight for use in prospecting, customer management and risk management. Services such as Hoovers, Dun & Bradstreet, and ZoomInfo collect business information from various sources, organize the data and more or less attempt to present the information in meaningful ways. However, such information may be outdated and does not necessarily reflect the true financial health of a business.

There exists a need to provide peer-to-peer business insight that is more timely, more accurate, and better correlated to the actual performance of a business.

### BRIEF SUMMARY OF THE INVENTION

Briefly, the present invention provides a method for determining the business rating of a business. The method includes the steps of electronically receiving rating information about the business from a plurality of reviewers; electronically weighting the rating information based on the source of the rating information; and electronically developing a rating score based on the weighted rating information.

The present invention further provides a non-transitory machine-readable storage medium for determining the business rating of the business.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a schematic diagram showing an exemplary flow of information into the system of the present invention and the output of rating information;

FIG. 2 is an exemplary graphical user interface (“GUI”) of a website homepage of the system of the present invention;

FIG. 3 is exemplary GUI of a user homepage of the system of the present invention; and

FIG. 4 is an exemplary flowchart illustrating how an individual rating affects the overall rating value of a business.

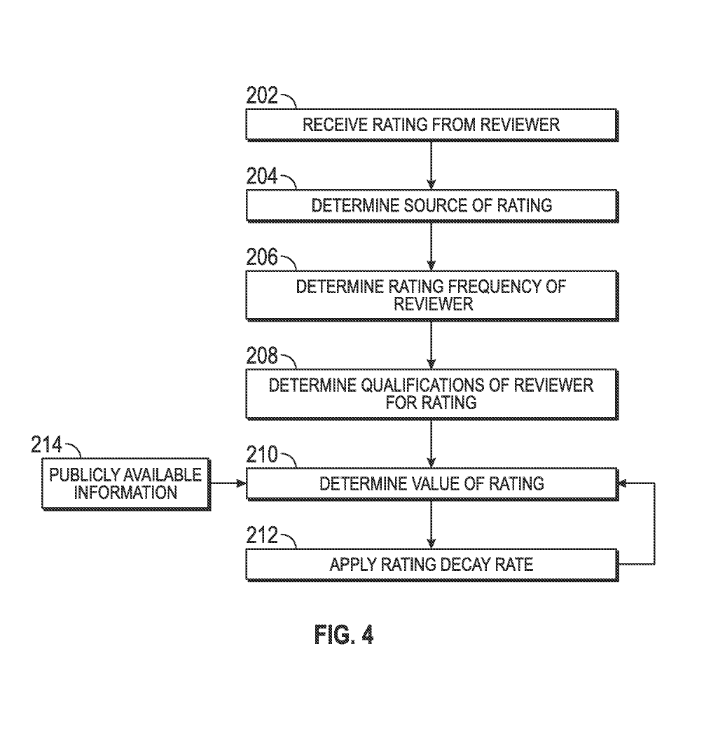

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Social networking allows a first party to comment on the quality of a second party for others to see, which helps the others to shape their opinion of the quality of the second party. While the second party is typically a business, the first party can be an individual or another business, such as a vendor, a partner, or a customer of the second party.

The present invention provides a system and method for allowing parties that interface with a business to comment on the quality of the business, which helps other parties that interface with the business to shape their opinion of the business. The commenting party can be in a peer-to-peer relationship with the business on several levels, including general peer-to-peer, peer-to-peer business-to-consumer credit rating, and peer-to-peer business-to-business.

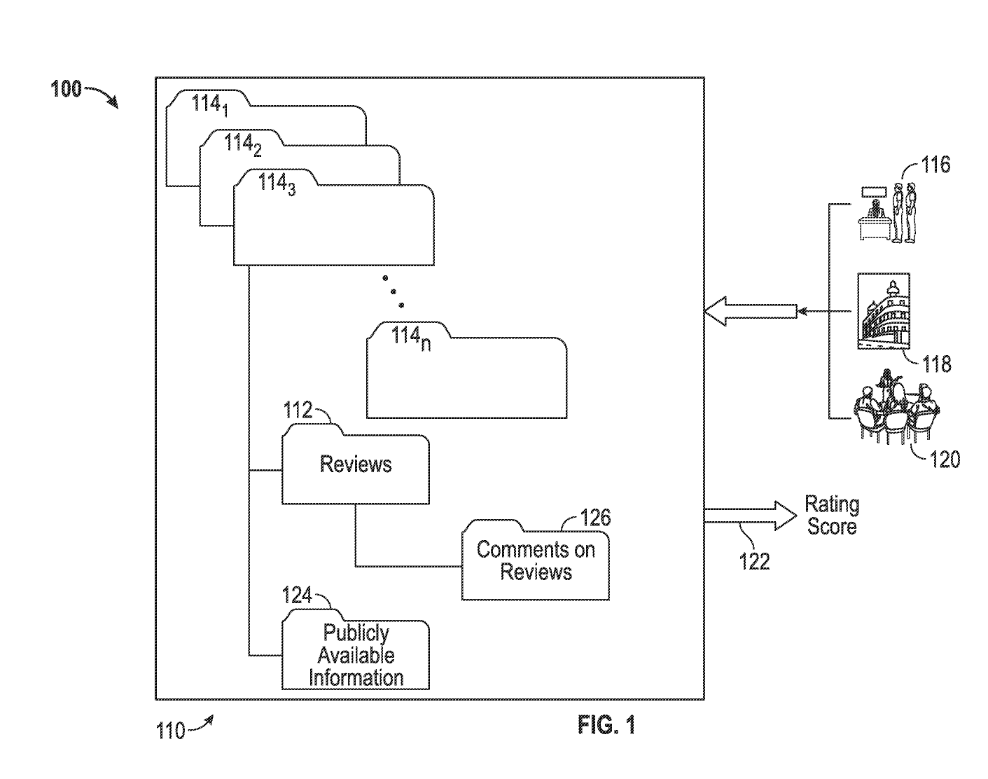

As shown FIG. 1, a business rating system 100 according to a first exemplary embodiment of the present invention accumulates real-time rating information from parties that are directly associated with the business and generates a numerical rating of the business, hereinafter called the business quality rating, based on the rating information. This numerical rating is provided to other parties that interface with business to provide an indication to those parties about the state of the business.

System 100 incorporates numerous different types of input into a database 110 in order to develop the business quality rating. Exemplary types of input may include peer reviews and ratings, business alerts, media reports and press releases, customer and vendor feedback, and reputations of the principals of the business as well as of the business itself. Additionally, user input can be provided through implicit third-party sources. For example, if a user grants access to LinkedIn® or Mint.com accounts via an intuit application programming interface (API), system 100 aggregates that data into meaningful metrics and uses the metrics as an input into the business rating, without explicit user input.

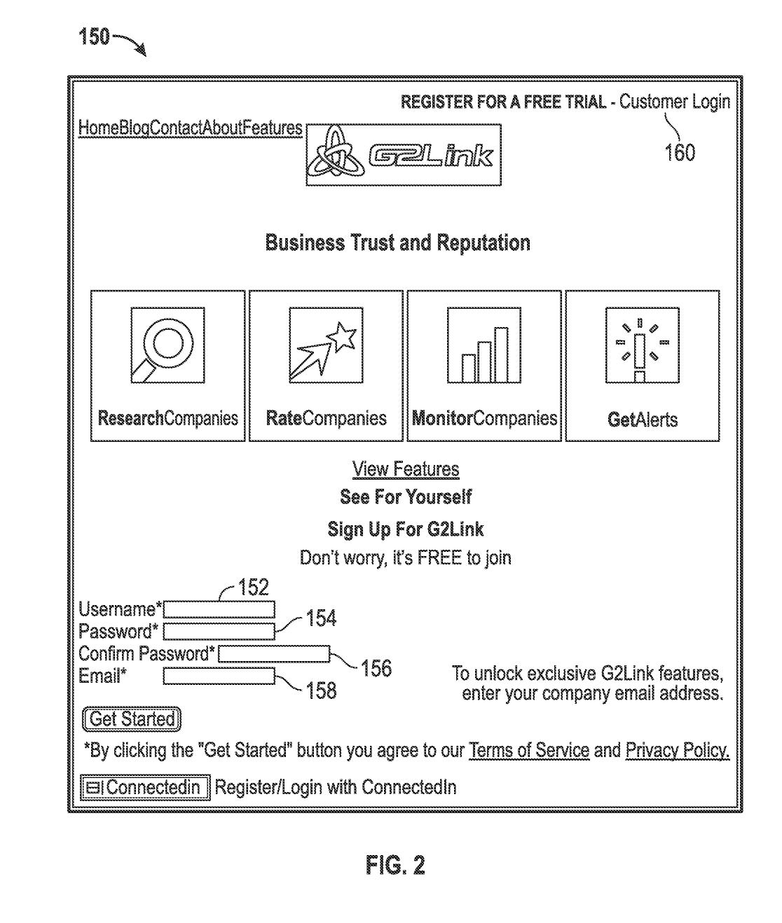

An exemplary GUI of a system homepage 150 of business rating system 100 is shown FIG. 2. System homepage 150 provides sign-in blocks 152-158 to allow a new user to access system 100. Alternatively, a previously registered user can click on a “Customer Login” button 160 to access system 100.

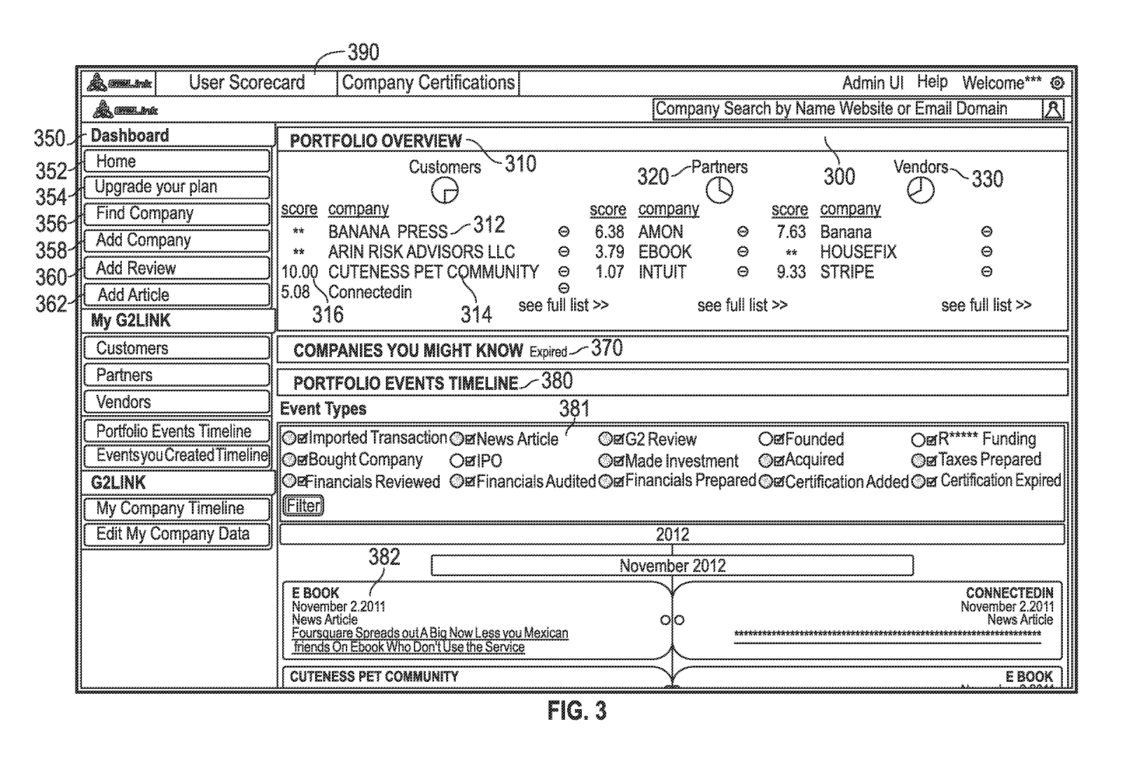

Upon entering sign-in information, an exemplary GUI of a user homepage 300, shown FIG. 3, is shown. User homepage GUI 300 includes a “Portfolio Overview” 310 that includes a listing 312 of companies that the user has selected to follow. Listing 312 includes the name of each followed company 314, along with the company's rating 316 as calculated by system 100. Portfolio Overview 310 also includes a listing of all partners 320 as well as vendors 330 that have been selected by the user to follow.

User homepage 300 further includes a “Dashboard” 350 that remains visible to the user regardless of whatever other GUI is being presented to the user. Dashboard 350 includes a “Home” button 352 that allows the user to click on the return to home page 300. Dashboard 350 also includes an “Upgrade Your Plan” button 354 that allows the user to upgrade from a free subscription to a paid subscription to system 100. In an exemplary embodiment, a paid subscription offers larger monitoring lists (i.e., 50-250 in each list vs. only 5 in the free subscription), allows a user to create private reviews within his/her social media groups, such as, for example, LinkedIn®, and provides access to a system 100 reputation score instead of only seeing the non-weighted average score.

Dashboard 350 further includes a “Find Company” button 356 that a user can click on to type in the name of the company and perform a search to determine whether the name of the company is already included in system 100. Alternatively, if the company is not already listed in system 100, the user can click on “Add Company” button 358 that allows the user to add the company to system 100.

Additionally, dashboard 350 includes an “Add Review” button 360 that allows a user to review a company included in portfolio overview 310. Also, dashboard 350 includes an “Add Article” review button 362 that allow the user to add an Internet website URL address for an article that discusses a business. While a user can only review businesses in their portfolio lists, any user can add an article about any company at any time. The reviews are used to calculate the rating of the particular company, which rating value depends at least partially on the quality of the reviewer. The quality of the reviewer may depend on several factors, including the number and types of prior reviews by the reviewer, the relationship of the reviewer relative to the company (customer, vendor, owner, etc.), as well as other parameters.

System 100 also includes the ability to recommend companies that a user may desire to follow. User home page 300 includes a listing 370 of companies that a user might know due to their proximity to his/her location. In an exemplary embodiment, the recommended list of companies is generated by a combination of three things: (1) list similarities from other similar users, (2) companies followed in the user's social media account, and (3) IP address proximity via an IP address-to-zip code reverse geocoding API service, which is known in the art.

User homepage 300 also includes a Portfolio Events Timeline 380 includes a list of parameters 381 that may influence the rating value of the company. Exemplary events include an important transaction, a review through system 100, funding raised, IPO, acquisition, financials reviewed by CPA, financials audited by CPA, a news article about the company, founding the company, the purchase of the company, investment in/by the company, and taxes prepared by CPA. Those skilled in the art, however, will recognize that additional events may also be used. Each event may be color-coded and used to identify the source of information about the particular company on a timeline 382.

Timeline 382 includes relevant information about the company, as well as the source of the information from the above-listed or other parameters. Data culled from the information available through timeline 382 is used to determine and/or adjust the rating of each company listed on timeline 382.

An exemplary method for determining the financial health of the business according to the present invention is shown in the schematic drawing of FIG. 1 and the flowchart 200 of FIG. 2. In step 202, system 100 receives rating information 112 from reviewers of a business 114. The rating information 112 can be entered manually by the reviewer by entering a desired rating value into a website that operates business rating system 100. Alternatively, rating information 112 can be input into system via an API that would enable system 100 to programmatically manage ratings for a particular business 114. For example, if business 114 pays an invoice within 30 days of its issuance, the API can automatically provide a higher rating for business 114 than if business 114 does not pay the invoice until 30 days past due.

A plurality of businesses 114₁ to 114ₙ are contained in database 110 but, for simplicity, businesses 114₁ to 114ₙ will be referred to herein as business 114. The reviewers of business 114 can be selected from the group consisting of customers 116 of business 114, business partners 118 with business 114, and vendors 120 of business 114, although it is envisioned that other parties may be able to review business 114 as well. For example, a landlord, mortgage company, bank, utility, or other party that interacts in some way with business 114 may also be a reviewer.

Based on information about the reviewers and their reviews, system 100 provides a rating score 122 for business 114. In an exemplary embodiment, a rating scale between 1 and 10 can be used to score business 114. A rating score 122 of between about 1 and about 3 can indicate a high risk business. A rating score 122 of between about 3 and about 6 can indicate a moderate risk business. A rating score 122 of between about 7 and about 10 can indicate a low risk business. Those skilled in the art, however, will recognize that other scales and other scale ranges can be used.

There are typically two scores that system 100 will display about a company. The first score is an average score, which is the arithmetic mean of all review scores created for the company. This is a snapshot of how the general population of users of system 100 feel about the company. The second score is a system score, which is a more nuanced approach than the simpler ‘popular vote’. The system score carefully balances many additional factors, such as the relative reputations of reviewers and the age of each review. The average score may be available to all users, but the system score may be available only to those users who have a paid subscription to use system 100.

For the system score, system 100 weights rating information based on the source of the rating information that is determined by system 100 in step 204. Each of the plurality of reviewers 116, 118, 120 has an associated quality rating that is used in assigning weighting values of the rating information. For example, a one-time customer 116 of the business 114 may be assigned a low quality rating such that the rating information provided by the one-time customer 116 of the business 114 may be given a lower weight than a long-term customer of the business 114 or a vendor 120 of the business 114, who is given a higher quality rating.

Further, the value of the quality rating is determined by the frequency of the rating information received by system 100 from each of the plurality of reviewers. The reviewer may not necessarily provide a large number of reviews for a particular business 114, but may provide a large number of reviews overall for a variety of different businesses. The quality rating of the reviewer, however, can be affected by the number and frequency of ratings for a particular type of business and is determined in step 206.

In step 208, the qualifications of the reviewer are determined by system 100. For example, if the business in question is an Italian restaurant and a particular reviewer has reviewed a significant number of Italian restaurants, the value of the reviewer's rating will be higher than if the reviewer has a limited number or even no prior reviews of Italian restaurants, even if the reviewer has a significant number of other types of business reviews.

Additionally, if the reviewer has reviewed a significant number of Mexican restaurants, then the quality rating of the reviewer with respect to Mexican restaurants is relatively high. If, however, a particular Italian restaurant is the first Italian restaurant that the reviewer has reviewed, and the quality rating of the reviewer with respect to Italian restaurants is relatively low.

Further, the quality rating factor can be further narrowed to a subcategory of the particular type of business. The Italian restaurant that is being reviewed may specialize in northern Italian cuisine. A first reviewer who has reviewed a significant number of Italian restaurants specializing in northern Italian cuisine will be given a higher quality rating factor than a second reviewer who only has a history of reviewing pizza parlors, even if the second reviewer has reviewed significantly more pizza parlors then the first reviewer has reviewed restaurants specializing in northern Italian cuisine.

In step 210, system 100 combines the number, quality rating, and types of comments and input for the business 114 and develops rating score 122 for the business 114 based on the weighted rating information input into database 110.

System 100 may adjust the rating score 122 for the business 114 based on the value of the rating score 122 of the business 114 over a predetermined period of time. For example, the rating score 122 of a business 114 with a consistently high rating score that has received consistently high ratings over a predetermined period of time is not necessarily adversely affected by a single particularly low rating. However, the rating score 122 of a business with a previous consistently high rating score that has received consistently lower ratings over predetermined period of time may be adversely affected by an additional particularly low rating, which may reflect a downturn in the quality or financial stability of the business 114.

Additionally, system 100 may adjust the rating score 122 of business 114 based on the rate of change of the rating score 122 over time. For example, if business 114 has received consistent ratings over a predetermined period of time, system 100 will maintain the consistent rating score 122 for business 114. However, if business 114 receives ratings that increase or decrease over the predetermined period of time, system 100 will adjust the rating score 122 for business 114 based on the direction (increasing or decreasing) of the ratings over that period of time.

In addition to using ratings provided by parties (customers 116, partners 118, vendors 120) of business 114, the system 100 also receives and, in step 212, uses publicly available information 124 about business 114 in order to calculate the business rating score. Such publicly available information 124 may be press releases, news reports, publications, and other sources. Publicly available information 124 about the business is received by system 100 from various sources, including manual and electronic scans from sources such as, for example, press releases and news articles, looking for keywords, such as, for example “bankruptcy”, “funding”, “new customer”, etc.

System 100 also recognizes that the value of a rating is time sensitive. For example, a rating that may be several months old, while reflecting the quality of the business 114 at that time, may be outdated due to intervening factors. As a result, that rating may not necessarily reflect the present quality of the business 114. Therefore, in step 212, the value of a quality rating decays over time. The direction of decay of the quality rating trends toward a midrange value such as, for example over a range of 0 to 5, toward a value of 2.5. That way, an excessively low or an excessively high rating only affects the overall rating score 122 of the business 114 for a period of time and a single quality rating that is out of the range of a large number of quality ratings does not skew the overall rating score 122 of the business 114 for longer than a short period of time.

The amount and rate of decay of a quality rating can depend on the quality of the reviewer 116, 118, 120 as well as the quality of the business 114 being rated. For example, the rating of a first reviewer who provides a single negative review of a business 114 that has a consistently high rating may decay at a higher rate and/or a higher amount than the rating of a second reviewer who provides a positive review of the same business 114. This quicker decay may reflect the fact that the first reviewer has a history of posting a significant number of reviews that have historically tracked the quality of the businesses that the first reviewer has reviewed.

In an exemplary embodiment, the rate of decay can be based on a percentage value over a period of time such as, for example, a change of 5% per week. Alternatively, the rate of decay can be based on a predetermined value over a period of time such as, for example, a change of 0.1 points per week.

System 100 may adjust the weight of rating information based upon the geographic location of the reviewer. For example, if the business 114 being reviewed is a local restaurant that provides a cuisine specific to that locality, the reviewer who lives in that locality and who is expected to know the quality of that cuisine is assigned a higher rating weight than an out-of-town visitor who is not expected to know the quality of that cuisine.

System 100 allows reviewers to review not only a business, but also to comment on other reviews of the business. System 100 adjusts the rating score based on the number and quality of the comments 126.

System 100 allows a company to collect feedback directly from its end users, and system 100 uses this data to create a User Value score. This User Value score, when compared over time or when contrasted against other companies, demonstrates how valuable a particular company's users are finding that company's application, relative to early versions and to other Web applications.

A company's overall User Value score is publically visible on the company's profile through system 100, and can be a point of pride for the company. When the company's User Value score is high enough, it can be a selling point for both traditional and crowd funding investors, as it represents a form of public trust in the company's products and services.

In addition to the social network aspect of providing ratings to a business 114, as an added incentive to encourage reviewers to review a business 114, system 100 provides a recognition system for the reviewers. In an exemplary embodiment, system 100 awards reviewers with incentive points based on the rating information received by system 100 from the reviewers. A particular user's incentive points are displayed on a “User Scorecard” 390, shown in GUI 300 in FIG. 3.

The value of the incentive points may be based on the amount and/or type of rating information received from that reviewer. The value of the incentive points may also correspond to predetermined statuses of the reviewer. For example, a vendor 120 that provides goods or services to a large number of businesses may have a higher status than a one-time customer 116 of a single business 114. Correspondingly, the vendor 120 may be awarded more incentive points per review than the one-time customer 116.

Further, as discussed above, system 100 allows reviewers to review not only a business 114, but also other reviews of the business. For example, subsequent reviewers may echo the opinion of a first reviewer, which would tend to validate the quality of the first reviewer's comments. In such a case, additional incentive points may be awarded to the first reviewer based on the input from the subsequent reviewers.

System 100 provides a list of the top reviewers based on their incentive points. Additionally, system 100 may categorize the reviewers based on predetermined incentive point levels. For example, a first range of total incentive points may qualify the reviewer for “Silver Status”, the second range of total incentive points, higher than the first range of total incentive points, may qualify the reviewer for “Gold Status”, and a third range of total incentive points, higher than the second range of total incentive points, may qualify the reviewer for “Platinum Status”.

In addition to awarding status level to reviewers based on their incentive point total, system 100 may provide other types of awards as well. For example, a reviewer who achieves “Platinum Status” may receive a monetary discount toward a subscription to use system 100.

In a specific exemplary embodiment of the present invention, system 100 includes an algorithm that receives input from different sources and assigns values to each input in order to arrive at a rating score.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method for determining the business rating of a business comprising the steps of:
(a) electronically receiving rating information about the business from a plurality of reviewers;
(b) electronically weighting the rating information based on the source of the rating information;
(c) electronically developing a rating score based on the weighted rating information;
(d) electronically allowing the plurality of reviewers to comment on the rating information received by others of the plurality of reviewers; and
(e) electronically adjusting the rating score based on the number and quality of the comments.

2. The method according to claim 1, wherein the plurality of reviewers are selected from the group consisting of customers, partners, and vendors.

3. The method according to claim 1, wherein each of the plurality of reviewers has an associated quality rating and wherein the quality rating is used in step (b).

4. The method according to claim 3, wherein the value of the quality rating decays over time.

5. The method according to claim 3, wherein the value of the quality rating is determined by the frequency of the rating information received by each of the plurality of reviewers.

6. The method according to claim 1, wherein step (b) further comprises weighting the rating information based on the geographic location of the source.

7. The method according to claim 1, wherein step (a) further comprises receiving publicly available information about the business.

8. (canceled)

9. The method according to claim 1, wherein each of the plurality of reviewers are awarded incentive points based on the amount of rating information received from that reviewer.

10. The method according to claim 9, wherein predetermined values of the incentive points correspond to predetermined statuses of the reviewer.

11. The method according to claim 1, further comprising the step of:
(d) electronically adjusting the rating score based on the value of the rating score over time.

12. The method according to claim 11, further comprising the step of:
(d) electronically adjusting the rating score based on the quality of each of the plurality of reviewers.

13. The method according to claim 11, further comprising the step of:
(d) adjusting the rating score over time by a percentage of the rating score.

14. The method according claim 11, further comprising the step of:
(d) adjusting the rating score over time by a predetermined value.

15. The method according to claim 11, further comprising the step of:
(d) electronically adjusting the rating score based on a rate of change of the rating score over time.

16. (canceled)

17. A method for determining the business rating of a business comprising the steps of:
(a) electronically receiving rating information about the business from a plurality of reviewers;
(b) electronically weighting the rating information based on the source of the rating information;
(c) electronically developing a rating score based on the weighted rating information;
(d) rewarding each of the plurality of reviewers based on the rating information received in step (a) based on input from others of the plurality of reviewers.

18. The method according to claim 1, further comprising, prior to step (b), electronically receiving rating information about the business from key words in electronic publications.

19. The method according to claim 1, further comprising electronically receiving rating information about the business from non-reviewer sources.

20. A non-transitory machine-readable storage medium, having encoded thereon program code, wherein, when the program code is executed by a machine, the machine implements a method for determining the business rating of a business comprising the steps of:
(a) electronically receiving rating information about the business from a plurality of reviewers;
(b) electronically weighting the rating information based on the source of the rating information; and
(c) electronically developing a rating score based on the weighted rating information.
